(19) United States
(12) Patent Application Publication
(10) Pub. No.: US 2025/0245081 A1
(43) Pub. Date: Jul. 31, 2025

(54) SYSTEMS AND METHODS FOR ARTIFICIAL INTELLIGENCE INTEGRATION IN A COMPLIANCE ENVIRONMENT

(71) Applicant: Cential AI, Inc., St. Louis, MO (US)

(72) Inventors: Andrew Gunter, MINNETRISTA, MN (US); David Ponder, WEBSTER GROVES, MO (US); Jannie Wentzel, WOODRUFF, SC (US)

(21) Appl. No.: 19/036,732

(22) Filed: Jan. 24, 2025

Related U.S. Application Data
(60) Provisional application No. 63/625,644, filed on Jan. 26, 2024.

(51) Int. Cl. G06F 9/54; G06F 40/30

(52) U.S. Cl. CPC G06F 9/546; G06F 40/30; G06F 2209/547

(57) ABSTRACT

An artificial intelligence integration system comprising a client system; an artificial intelligence large language model system; a middleware system connected to the client system and the artificial intelligence large language model system, the middleware system comprising an application programming interface integration layer; a data privacy filter; a prompt engineering module; a response processing module; and a use-case library. The middleware system packages data received from the client system before providing it to the artificial intelligence large language model in order to address confidentiality, governmental compliance, and other risk compliance.

### BACKGROUND OF THE INVENTION

The present disclosure relates to novel and advantageous systems and methods for artificial intelligence integration, and use of artificial intelligence, in a compliance environment.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Organizations confront many challenges that may be addressed by artificial intelligent (“AI”). Organizations struggle with limited resources and growing pressure due to increased demands, and they aim to achieve efficiency through labor automation in content generation and correlation, which is a problem that may be addressed, in part or in whole, by AI. These organization may struggle with seamlessly integrating AI into their technology platforms in a manner that ensures data privacy and compliance and also enables AI to deliver contextual responses tailored to their specific use cases, including but not limited to IT operations, sales, legal, and governance, risk management, and compliance. In adopting AI, there are challenges like ability to achieve an integrated AI-enabled environment, unauthorized AI use, data privacy concerns, standardization, and effectiveness. Yet at least as of the date of this filing, there is a growing concern about confidentiality of information shared with both public and private AI large language models (“LLMs”), compliance with existing organizational operating procedures when using AI, the relevancy or accuracy outputs from LLMs and AI, and even the ethics of use of AI in organizations.

As AI becomes more integrated into organizational activities in many industries from, there is a need for a solution that facilitates smooth AI integration with various technology platforms, while ensuring data privacy and other compliance concerns.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

An artificial intelligence integration system comprises a client system, an artificial intelligence large language model system, and a middleware system connected to the client system and the artificial intelligence large language model system. The middleware system comprises: an application programming interface integration layer; a data privacy filter; a prompt engineering module; a response processing module; and a use-case library. In some embodiments, the client system and the artificial intelligence large language model system are separated from one another by the middleware system.

In at least one embodiment, a method for automatically generating a compliant response from an AI large language model, the method comprises the steps of receiving, from a client computing device, a data package from a client system; scrubbing, by a middleware computing device, the data package into scrubbed data; wrapping, by the middleware computing device, the scrubbed data with contextual prompting to create wrapped data; transmitting, by the middleware computing device, the wrapped data and a contextual prompt to a language module; receiving, from the AI large language model; contextual response data; and transmitting, by the middleware computing device, the contextual response data to the client computing device.

In a further embodiment, an apparatus comprises a memory configured to store instructions; and a processor configured to execute the instructions to receive a data package from a client system, scrub the data package into scrubbed data, wrap the scrubbed data with contextual prompting to create wrapped data, transmit the wrapped data and a contextual prompt to a language module, receive contextual response data from the AI large language model; and transmit the contextual response data to the client system.

A computer program product for automatically generating a compliant response from an AI large language model, the computer program product comprising a computer readable storage medium having program instructions embodied therewith, the program instructions executable by a processor to cause the processor to receive a data package from a client system, scrub the data package into scrubbed data, wrap the scrubbed data with contextual prompting to create wrapped data, transmit the wrapped data and a contextual prompt to a language module, receive contextual response data from the AI large language model; and transmit the contextual response data to the client system.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a schematic view of an artificial intelligence integration system according to at least one embodiment of the present disclosure.

FIG. 2 is a schematic view of an artificial intelligence integration system according to at least one embodiment of the present disclosure.

FIG. 3 is a schematic view of a method of artificial intelligence integration according to at least one embodiment of the present disclosure.

### DETAILED DESCRIPTION

The present disclosure describes novel and advantageous systems and methods to facilitate AI integration with various technology platforms, while ensuring data privacy and/or confidentiality. As described herein, the systems and methods employ a data privacy filter to scrub data before processing in AI, which helps to address privacy concerns. Additionally, through prompt engineering, the systems of the present disclosure hold organizational information that enables the AI to provide more contextually relevant responses for specific use cases. By automating content generation and correlation, it significantly enhances efficiency, transforming labor-intensive processes into automated workflows, thus effectively solving the problems at hand. The systems and methods described herein are middleware solutions that can integrate LLMs and other AI large language models to any technology platform using application programming interfaces (“APIs”), enabling substantially seamless integration while ensuring data privacy. The systems and methods of the present disclosure go beyond merely facilitating automation, they ensure that AI responses are contextually enriched and tailored to specific organization use cases. This combination of secure data handling, contextual relevance, and the flexibility provided by its middleware nature provides an improvement over the current state of the art for organizations aiming to harness the power of AI across their technology ecosystems.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, and/or components have not been described in detail so as not to obscure the discussion. Further, it is understood that elements on the figures having like reference numerals (e.g. 162 and 462) may have any or all of the features as earlier described for such elements.

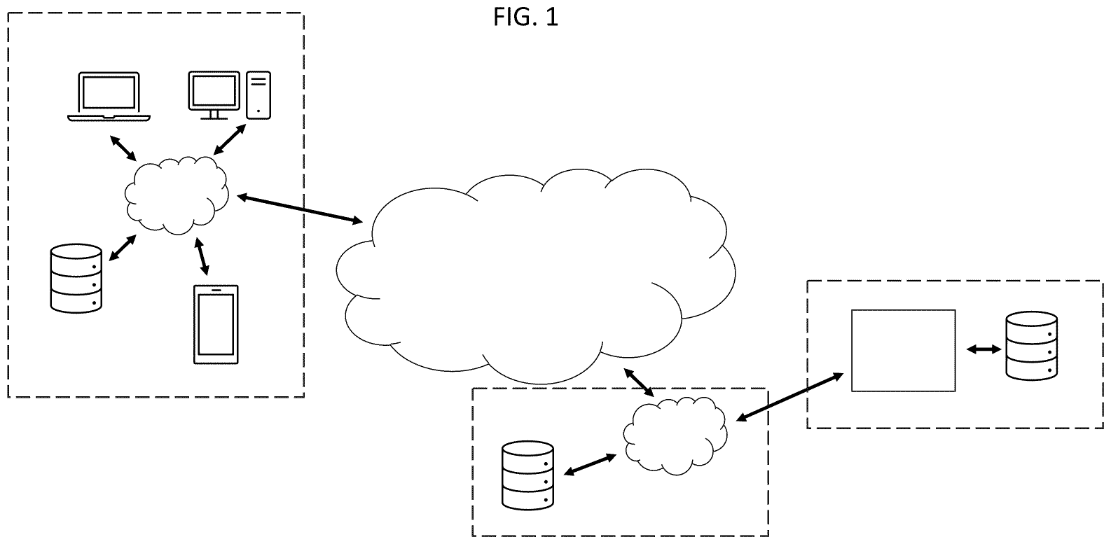

FIG. 1 shows one embodiment of system 100 for artificial intelligence (AI) integration system according to one or more embodiments of the present invention. System 100 comprises a client system 102, an AI large language model 104, and a middleware system 106. The client system 102 and at least the middleware system 106 are connected via a network 101. The client system 102 may comprise one or more client computing devices 103, such as servers, laptops, computers, smartphones, and other devices that have a processor and a memory connected via a network 105. The AI large language model 104 may comprise a server 107 with a processor and a memory. As shown in FIG. 1, the client system 102 is in electronic communication with the middleware system 106, but not with the AI large language model 104. The AI large language model 104 is in electronic communication with the middleware system 106, but not with the client system 102. In at least one embodiment, the AI large language model 104 is in direct electronic communication with the middleware system 106, but in other embodiments, the AI large language model 104 is in indirect electronic communication with the middleware system 106 with another intervening translation system, prompt system, or similar system between the middleware system 106 and the AI large language model 104.

The middleware system 106 may comprise a server 109 with a processor and a memory and/or may comprise other computing devices. The middleware system 106 may, in some embodiments, be deployable as a Software as a Service (SaaS) model or a Platform as a Service (PaaS) model. For SaaS implementation, the client can use the middleware system 106 running on a cloud infrastructure and the middleware system 106 may be accessible from one or more client devices of the client system 102 through a client interface, even as a web browser (e.g., web-based email). The client does not manage or control the infrastructure of the middleware system 106 including network, servers, operating systems, storage, or even individual application capabilities, with the possible exception of limited consumer-specific application configuration settings. For PaaS implementation, client can use the middleware system 106 running on a cloud infrastructure and the middleware system 106 may be accessible from one or more client devices of the client system 102 through applications created using programming languages and tools supported by the provider and specific to the client. Again, the client does not manage or control the underlying infrastructure of the middleware system 106, including networks, servers, operating systems, or storage, but has control over the deployed applications and possibly application-hosting environment configurations. The middleware system 106 may be stored or accessible from a server, and a client system 102 can access, directly or indirectly, the middleware system 106 via one or more interfaces, which may in some embodiments be an interface specific to the client.

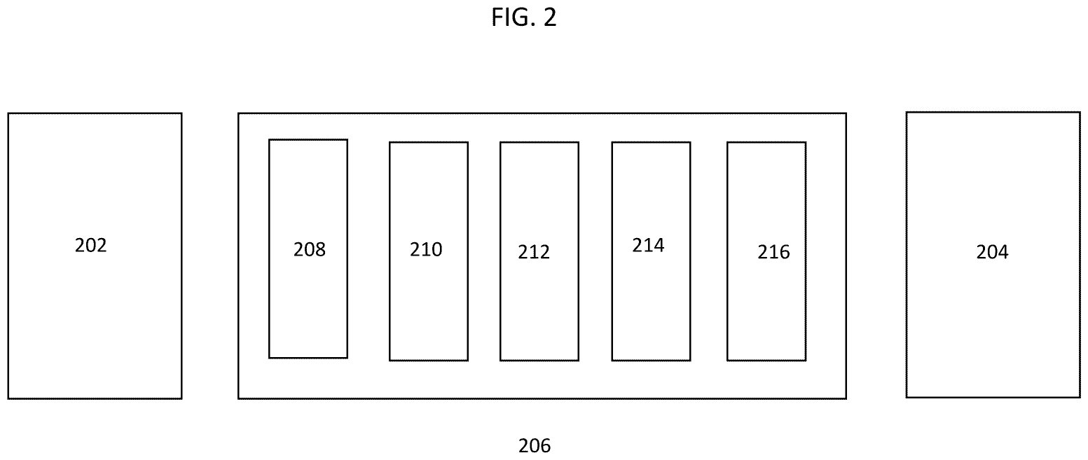

FIG. 2 shows a further schematic view of the artificial intelligence (“AI”) integration system 200 with client system 202, middleware system 206, and AI large language model 204. The AI large language model 204 can be a large language model (“LLM”) or other deep learning algorithm. As shown in FIG. 2, the middleware system 206 includes at least an application programming interface (“API”) integration layer 208, a data privacy filter 210, a prompt engineering module 212, a response processing module 214, and a use-case library 216.

The API integration layer 208 implements conditional logic to check the status of connections between the middleware system 206 and the AI large language model 204, as well as with the middleware system 206 and the client system 202. The API integration layer 108 further comprises logic to handle errors, reconnect the middleware system 206 to each of the client system 202 and the AI large language model 204, and log errors for troubleshooting. The API integration layer 208 further comprises routing logic to route data to the AI large language model 204.

The data privacy filter 210 applies a set of rules to scrub sensitive data from client data received by the middleware system 206 from the client system 202. In some embodiments, the set of rules may comprise blacklisting, whitelisting, pattern matching, and combinations thereof. As an example, if a portion of the data received by the middleware system 206 from the client system matches a blacklisting rule, that portion of the data is removed or obfuscated from the data.

The prompt engineering module 212 creates prompts (which may be prompt engineering date) based on scrubbed data received from the data privacy filter 210 and wraps the scrubbed data into wrapped data. In some embodiments, the prompt engineering module 212 is in communication with the use-case library to create pre-defined formatting for the wrapped data or pre-defined prompts. In some embodiments, the prompt engineering module 212 communicated with the AI large language model 204 through the API integration layer 208. In some embodiments, the prompt engineering module submits a first set of prompt engineering language, the client data, and a second set of prompt engineering language. The client data is therefore layered between the first set of prompt engineering language and the second set of prompt engineering language to wrap the client data between the two sets of prompt engineering data to form wrapped data.

The response processing module 214 interacts with the API integration layer 208 and the AI large language model 204 to receive contextual response data from the AI large language model 204 and create responsive data to send via the API integration layer 108 to the client system 202.

The use-case library 216 comprises contextual prompting logic based on predefined use cases for particular applications in one or more industries. The use-case library 216, in some embodiments, may be continually or automatically updated to include new contextual prompting logic based on new or predefined use cases for particular applications in one or more industries. Use-case library 216 is in communication with, and acts as a resource for, the prompt engineering module 212. When the prompt engineering module 212 creates prompts it may, in one or more embodiments, receive prompt guidance from the use-case library 212 to align its prompts with particular use cases, such as governmental, risk, and compliance use cases.

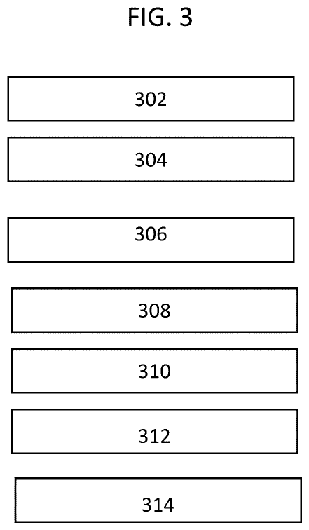

In at least one embodiment of a method of artificial intelligence (“AI”) integration 300 according to the disclosure of the present invention and shown in FIG. 3, a user first enters some data into a field within the client system at step 302 to form a data record. Step 302, the client data entry step, is initiated on the client's platform or within the client system and is separate from the middleware system. At step 304, the user selects save by clicking, checking, or otherwise denoting that the data record is saved the data into a data package for AI integration. In some embodiments, the record may be saved automatically where the client data entry step meets certain criteria. Saving the data system at step 304 also triggers the client system to send the package to the middleware system, and at step 306, the middleware system retrieves the data package via the API integration layer. At step 308, the data privacy filter receives the data package and scrubs any sensitive data according to developed whitelisting, blacklisting or pattern recognition parameters to ensure confidentiality, data privacy, and compliance. At step 310, following the scrubbing step of step 308, the prompt engineering module receives the scrubbed data, wraps it in contextual prompting received from the use-case library based on predefined logic or templates of the use-case library to create wrapped data, and prepares the wrapped data and a contextual prompt to send to the language module. At step 312, the middleware generates wrapped data (i.e. data wrapped between the first set of prompt engineering language and the second set of prompt engineering language) sends it to the AI large language model (such as an LLM like ChatGPT) and a, and receives contextual response for the wrapped data from the AI large language model. Upon receipt of the contextual response data from the language learning module, at step 314, the response processing module structures responsive data to provide to the client system and the API integration layer pushes the responsive data back to the client system. In at least one embodiment, the responsive data then updates the data record in the client system.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments for purposes of illustration only. One skilled in the art will readily recognize from the discussion herein that alternative embodiments of the structures and methods illustrated herein may be employed without departing from the principles described herein.

While particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

While the systems and methods described herein have been described in reference to some exemplary embodiments, these embodiments are not limiting and are not necessarily exclusive of each other, and it is contemplated that particular features of various embodiments may be omitted or combined for use with features of other embodiments while remaining within the scope of the invention.

What is claimed is:

1. An artificial intelligence integration system comprising:
a client system;
an artificial intelligence large language model system;
a middleware system connected to the client system and the artificial intelligence large language model system, the middleware system comprising:
an application programming interface integration layer;
a data privacy filter;
a prompt engineering module;
a response processing module; and
a use-case library.

2. The artificial intelligence integration system of claim 1, wherein the client system and the artificial intelligence large language model system are separated from one another by the middleware system.

3. A method for automatically generating a compliant response from an artificial intelligence large language model, the method comprising:
receiving, from a client computing device, a data package from a client system;
scrubbing, by a middleware computing device, the data package into scrubbed data;
wrapping, by the middleware computing device, the scrubbed data with contextual prompting to create wrapped data;
transmitting, by the middleware computing device, the wrapped data and a contextual prompt to a language module;
receiving, from the artificial intelligence large language model; contextual response data;
transmitting, by the middleware computing device, the contextual response data to the client computing device.

4. An apparatus comprising:
a memory configured to store instructions; and
a processor configured to execute the instructions to:
receive a data package from a client system;
scrub the data package into scrubbed data;
wrap the scrubbed data with contextual prompting to create wrapped data;
transmit the wrapped data and a contextual prompt to a language module;
receive contextual response data from the artificial intelligence large language model; and
transmit the contextual response data to the client system.

5. A computer program product for automatically generating a compliant response from an artificial intelligence large language model, the computer program product comprising a computer readable storage medium having program instructions embodied therewith, the program instructions executable by a processor to cause the processor to:
receive a data package from a client system;
scrub the data package into scrubbed data;
wrap the scrubbed data with contextual prompting to create wrapped data;
transmit the wrapped data and a contextual prompt to a language module;
receive contextual response data from the artificial intelligence large language model; and
transmit the contextual response data to the client system.
